(19) United States
(12) Patent Application Publication
(10) Pub. No.: US 2016/0028533 A1
(43) Pub. Date: Jan. 28, 2016

(54) ADAPTIVE UPLINK-DOWNLINK SWITCHING TIME FOR HALF DUPLEX OPERATION

(71) Applicant: TELEFONAKTIEBOLAGET L M ERICSSON (PUBL), Stockholm (SE)

(72) Inventors: Muhammad Kazmi, BROMMA (SE); Johan BERGMAN, STOCKHOLM (SE); Gary BOUDREAU, Kanata (CA); Iana SIOMINA, TÄBY (SE); Emre YAVUZ, STOCKHOLM (SE)

(21) Appl. No.: 14/432,001

(22) PCT Filed: Feb. 3, 2015
(86) PCT No.: PCT/SE2015/050116

§ 371 Date: Mar. 27, 2015

Related U.S. Application Data
(60) Provisional application No. 61/935,226, filed on Feb. 3, 2014.

(51) Int. Cl. H04L 5/16; H04W 72/04

(52) U.S. Cl. CPC H04L 5/16; H04W 72/0446; H04W 72/0413; H04W 72/042

(57) ABSTRACT

According to some embodiments, a method in a user equipment (UE), the UE capable of operating in half-duplex mode and is served by a network node, comprises obtaining a parameter indicative of a round trip time for a radio communication between the UE and the network node and comparing the obtained parameter with a threshold. The method further comprises determining, based on a result of the comparison of the parameter and the threshold, a switching time for switching the UE between uplink and downlink time resources and switching between uplink and downlink time resources within the determined switching time. In particular embodiments, the switching time comprises a first number of time resources (e.g., one) if the parameter is less than the threshold and a second number of time resources (e.g., two) if the parameter is greater than the threshold.

### TECHNICAL FIELD

Particular embodiments are directed to wireless communications and, more particularly, to adaptive uplink-downlink switching time for half-duplex operation.

### BACKGROUND

In a typical cellular radio system, wireless terminals (also referred to as user equipment unit nodes, UEs, mobile terminals, and/or mobile stations) communicate via a radio access network (RAN) with one or more core networks, which provide access to data networks, such as the Internet, and/or the public-switched telecommunications network (PSTN). The RAN covers a geographical area that is divided into cell areas, with each cell area being served by a radio base station (also referred to as a base station, a RAN node, a “NodeB”, and/or enhanced NodeB “eNodeB”). A cell area is a geographical area where radio coverage is provided by the base station equipment at a base station site. The base stations communicate through radio communication channels with wireless terminals within range of the base stations.

Wireless terminals may operate in full-duplex or half-duplex mode. In half-duplex (HD), or more specifically half-duplex FDD (HD-FDD), the uplink and downlink transmissions take place on different paired carrier frequencies, but not simultaneously in time in the same cell. The uplink and downlink transmissions take place in different time resources (e.g., symbols, time slots, subframes, or frames). In other words, uplink and downlink subframes do not overlap in time. The number and location of downlink, uplink, or unused subframes may vary per frame or per multiple frames. For example, in one frame (e.g., frame #1), subframes 9, 0, 4 and 5 may be used for downlink transmission and subframes 2, 5 and 7 may be used for uplink transmission. In another frame (e.g., frame #2), subframes 0 and 5 may be used for downlink transmission and subframes 2, 3, 5, 7, and 8 may be used for UL transmission.

The transition between uplink and downlink subframes may be performed by a switching action. The switching, or transition, is used in a device (e.g., radio receiver and radio transmitter), which employ half-duplex. For example, the device may be a network node, UE, or both. In Long Term Evolution (LTE) HD-FDD operation, a UE may be HD-FDD and a base station may typically be full-duplex FDD (FD-FDD). Switching may cause interruptions for multiple reasons. Switching may cause an interruption because of a change in the frequency of operation. Switching may cause an interruption when accounting for timing advance, which depends upon maximum cell range (e.g., cell size/cell radius). Certain subframes, therefore, are unused to account for switching interruption between uplink and downlink subframes. Unused subframes (or unused time slots or unused time units) refer to the subframes in which a UE does not transmit and/or receive any radio signals. In other words, the UE is not mandated to receive and/or transmit any radio signals during unused subframes or time units. These unused subframes occur between uplink and downlink subframes. Typically, the number of unused subframes may be 1, 2, or more. The frequency of occurrence of unused subframes depends upon the frequency with which the switching is performed.

### SUMMARY

According to some embodiments, a method in a user equipment (UE), where the UE is capable of operating in half-duplex mode and is served by a network node, comprises obtaining a parameter indicative of a round trip time for a radio communication between the UE and the network node and comparing the obtained parameter with a threshold. The method further comprises determining, based on a result of the comparison of the parameter and the threshold, a switching time for switching the UE between uplink and downlink time resources and switching between uplink and downlink time resources within the determined switching time.

In particular embodiments, the switching time comprises a first number of time resources if the parameter is less than the threshold and a second number of time resources if the parameter is greater than the threshold. In particular embodiments, the first number of time resources is one and the second number of time resources is two.

According to some embodiments, a method in a network node serving a UE that is capable of operating in half-duplex mode comprises obtaining a parameter indicative of a round trip time for a radio communication between the UE and the network node. The method further comprises comparing the obtained parameter with a threshold and determining, based on a result of the comparison of the parameter and the threshold, a switching time for switching the UE between uplink and downlink time resources, storing the switch time associated with the UE, and communicating the parameter to the UE.

According to some embodiments, a UE that is capable of operating in half-duplex mode and is served by a network node comprises one or more processors and at least one memory. The memory contains instructions executable by the one or more processors whereby the UE is operable to obtain a parameter indicative of a round trip time for a radio communication between the UE and the network node, the one or more processors are further operable to compare the obtained parameter with a threshold and determine, based on a result of the comparison of the parameter and the threshold, a switching time for switching the UE between uplink and downlink time resources. The one or more processors are further operable to switch between uplink and downlink time resources within the determined switching time.

According to some embodiments, a network node serving a UE that is capable of operating in half-duplex mode comprises one or more processors and at least one memory. The memory contains instructions executable by the one or more processors whereby the network node is operable to obtain a parameter indicative of a round trip time for a radio communication between the UE and the network node. The one or more processors are further operable to compare the obtained parameter with a threshold and determine, based on a result of the comparison of the parameter and the threshold, a switching time for switching the UE between uplink and downlink time resources, store the switch time associated with the UE; and communicate the parameter to the UE.

Particular embodiments may exhibit some of the following technical advantages. A network node has a finite amount of radio resources available in the time and frequency domains to communicate with the wireless devices that it serves. Particular embodiments may efficiently use available radio resources (e.g., uplink and downlink subframes in the time domain) between a wireless device and a network node by adaptively selecting the switching time based on one or more criteria or measurements. For example, a UE may conserve subframes by switching from uplink to downlink in one subframe instead of two subframes. By conserving subframes, a network node may be able to assign more radio resources for scheduling data transmission to a UE. A network node has fewer constraints when scheduling data transmission to a UE because, on the average, fewer radio resources are wasted or are unused when switching between uplink and downlink time resources.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example wireless network, according to some embodiments;

FIG. 2 illustrates an example Orthogonal Frequency-Division Multiplexed (OFDM) symbol;

FIG. 3 illustrates an example radio frame;

FIG. 4 illustrates an uplink-downlink timing relationship;

FIG. 5 is a signaling diagram of example signaling between a network node and a user equipment, according to some embodiments;

FIG. 6 is a flow diagram of a method in a user equipment of performing an uplink/downlink switch, according to particular embodiments;

FIG. 7 is a flow diagram of a method in a network node of communicating a parameter for uplink/downlink switching to a user equipment, according to particular embodiments;

FIG. 8 is a block diagram illustrating an example embodiment of a user equipment; and

FIG. 9 is a block diagram illustrating an example embodiment of a network node.

### DETAILED DESCRIPTION

Particular embodiments will now be described more fully hereinafter with reference to the accompanying drawings, however, other embodiments may include many different forms and should not be construed as limited to the examples set forth herein. Embodiments of the disclosure need not be mutually exclusive, and components described with respect to one embodiment may be used in another embodiment.

For purposes of illustration and explanation only, particular embodiments are described in the context of operating in a Radio Access Network (RAN) that communicates over radio communication channels with wireless terminals (also referred to as UEs). It will be understood, however, any suitable type of communication network could be used. As used herein, a wireless terminal or UE can include any device that receives data from a communication network, and may include, but is not limited to, a mobile telephone (“cellular” telephone), laptop/portable computer, pocket computer, hand-held computer, desktop computer, laptop embedded equipment (LEE), laptop mounted equipment (LME), USB dongle, a machine to machine (M2M) or MTC type device, a sensor with a wireless communication interface, Customer Premise Equipment (CPE), etc.

In some embodiments of a RAN, several base stations may be connected (e.g., by landlines or radio channels) to a radio network controller (RNC). A radio network controller, also sometimes termed a base station controller (BSC), may supervise and coordinate various activities of the plural base stations connected thereto. A radio network controller may be connected to one or more core networks. According to some other embodiments of a RAN, base stations may be connected to one or more core networks without a separate RNC(s) between, for example, with functionality of an RNC implemented at base stations and/or core networks. In some embodiments, generic terminology such as “radio network node” or simply “network node (NW node)”, is used. A network node may be any kind of network node such as a base station, radio base station, base transceiver station, base station controller, network controller, evolved Node B (eNB), Node B, relay node, access point, radio access point, Remote Radio Unit (RRU) Remote Radio Head (RRH), and so forth.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) technology. UTRAN, short for UMTS Terrestrial Radio Access Network, is a collective term for the Node B's and Radio Network Controllers which make up the UMTS radio access network. Thus, UTRAN is essentially a radio access network using wideband code division multiple access for UEs.

The Third Generation Partnership Project (3GPP) has undertaken to further evolve the UTRAN and GSM based radio access network technologies. In this regard, specifications for the Evolved Universal Terrestrial Radio Access Network (E-UTRAN) are ongoing within 3GPP. The Evolved Universal Terrestrial Radio Access Network (E-UTRAN) comprises the Long Term Evolution (LTE) and System Architecture Evolution (SAE).

Note that although certain terminology from 3GPP (3rd Generation Partnership Project) LTE (Long Term Evolution) is used in some example embodiments, this should not be seen as limiting. Other wireless systems, such as WCDMA, HSPA, WiMax (Worldwide Interoperability for Microwave Access), UMB (Ultra Mobile Broadband), HSDPA (High-Speed Downlink Packet Access), GSM (Global System for Mobile Communications), etc., may be used in other embodiments.

Also note that terminology such as base station (also referred to as NodeB, eNodeB, or Evolved Node B) and wireless terminal (also referred to as User Equipment node or UE) should be considering non-limiting and does not imply a certain hierarchical relation between the two. In general, a base station (e.g., a “NodeB” or “eNodeB”) and a wireless terminal (e.g., a “UE”) may be considered as examples of respective different communications devices that communicate with each other over a wireless radio channel. While embodiments discussed herein may focus on wireless transmissions in an uplink-downlink from a NodeB to a UE, embodiments of the disclosed concepts may also be applied in any suitable type of network, including both homogeneous and heterogeneous configurations. Thus, the base stations involved in the described configurations may be similar or identical to one another, or may differ in terms of transmission power, number of transmitter-receiver antennas, processing power, receiver and transmitter characteristics, and/or any other functional or physical capability.

With the proliferation of user friendly smart phones and tablets, the usage of high data rate services such as video streaming over the mobile network is becoming commonplace, greatly increasing the amount of traffic in mobile networks. Thus, there is a great urgency in the mobile network community to ensure that the capacity of mobile networks keeps up increasing with this ever-increasing user demand. The latest systems such as Long Term Evolution (LTE), especially when coupled with interference mitigation techniques, have spectral efficiencies very close to the theoretical Shannon limit. The continuous upgrading of current networks to support the latest technologies and densifying the number of base stations per unit area are two of the most widely used approaches to meet the increasing traffic demands.

A particular type of user equipment uses Machine-to-machine (M2M) communication (or machine type communication (MTC)) to establish communication between machines and between machines and humans. The communication may comprise signaling, user data exchange, measurement data exchange, configuration information exchange, etc. Device size may vary from that of a wallet to that of a base station. M2M devices may be used for applications like sensing environmental conditions (e.g., temperature reading), metering or measurement (e.g., electricity usage, etc.), fault finding, error detection, etc. In these applications, M2M devices may be active for short period over a consecutive duration depending upon the type of service (e.g., about 200 ms in a 2 second period, about 500 ms in a 60 minute period, etc.). M2M devices may also measure on other frequencies or other radio access technologies (RATs).

A category of M2M devices may be referred to as a low cost device. For example, cost reduction can be realized by limiting a UE device to a single receiver implementation. Cost may be further reduced by limiting a UE device to a single receiver with half-duplex FDD capability. This prevents the need for a duplex filter, because a UE does not transmit and receive at the same time.

Another category of M2M devices may support enhanced UL and/or DL coverage. These devices may be installed at locations where path loss between an M2M device and a base station can be very large. An example is when an M2M device functions as a sensor or metering device located in a remote location such as a basement of a building. In such scenarios, reception of a signal from a base station may be challenging. For example, the path loss can be 15-20 dB worse than when compared to normal operation. One way to cope with such challenges is to enhance the coverage in uplink or in downlink. Such enhancements may be realized by employing one or more techniques in the UE and/or in the network node for enhancing the coverage (e.g., boosting DL transmit power, boosting UL transmit power, enhanced UE receiver, signal repetition, etc.).

Wireless terminals may operate in full-duplex or half-duplex mode. In half-duplex, such as HD-FDD, the uplink and downlink transmissions take place in different time resources (e.g., symbols, time slots, subframes, or frames). Uplink and downlink subframes do not overlap in time. The number and location of downlink, uplink, or unused subframes may vary per frame or per multiple frames. The transition between uplink and downlink subframes may be performed by a switching action. The switching action may cause interruptions for multiple reasons. Switching may cause an interruption, for example, because of a change in the frequency of operation and/or to account for timing advance. Certain subframes are unused between uplink and downlink subframes to account for the switching interruption. A high number of unused subframes may lead to inefficient use of radio resources.

An object of the present disclosure is to obviate at least these disadvantages and provide an improved method to perform switching between uplink and downlink. Embodiments of the present disclosure may use improved procedures to adaptively determine an uplink/downlink switching time. In some embodiments, a method can be implemented in a network node (e.g., serving eNB) to adaptively determine a switching time for a UE and signal the switching time to the UE.

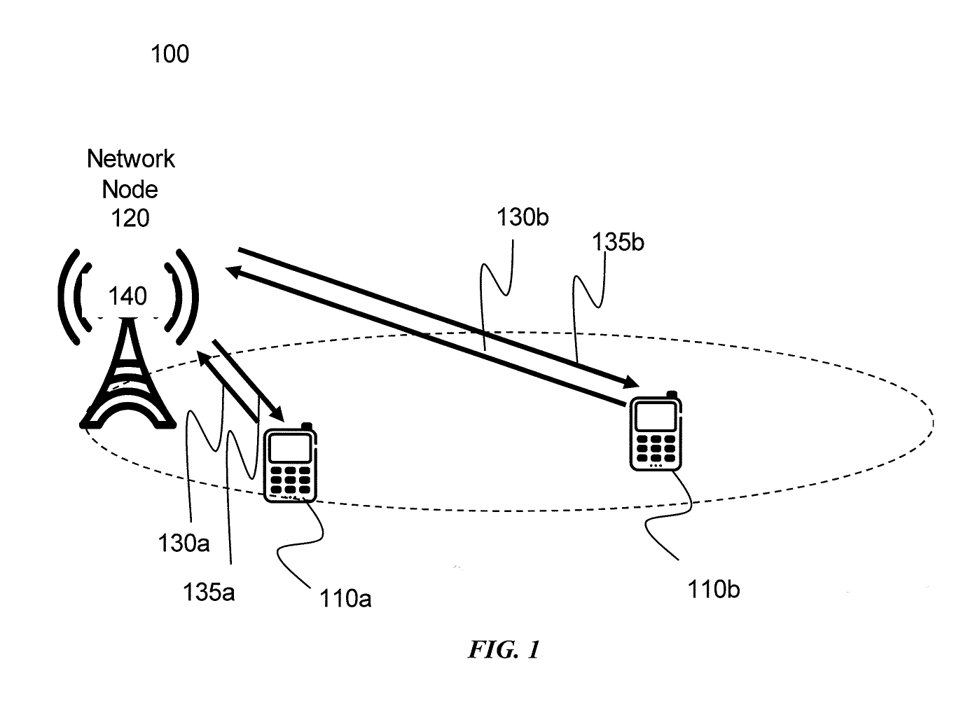

Particular embodiments are described with reference to FIGS. 1-9 of the drawings, like numerals being used for like and corresponding parts of the various drawings. LTE is used throughout this disclosure as an example cellular system, but the ideas presented herein apply to other wireless communication systems as well.

FIG. 1 is a block diagram illustrating an example wireless network, according to some embodiments. Wireless network 100 includes one or more wireless devices 110 (such as mobile phones, smart phones, laptop computers, tablet computers, MTC devices, or any other devices that can provide wireless communication) and a network node 120 (such as a base station or eNodeB). A wireless device 110 may also be referred to as a user equipment or UE. Network node 120 serves a particular coverage area or cell.

In general, wireless devices 110 that are within coverage of network node 120 communicate with network node 120 by transmitting and receiving wireless signals 130 and 135. For example, wireless devices 110 and network node 120 may communicate wireless signals 130 and 135 containing voice traffic, data traffic, and/or control signals. Wireless signals may include both downlink transmissions 135 (from network node 120 to wireless devices 110) and uplink transmissions 130 (from wireless devices 110 to network node 120). A network node 120 communicating voice traffic, data traffic, and/or control signals to wireless device 110 may be referred to as a serving network node 120 for the wireless device 110.

Network node 120 transmits wireless signals 135 and receives wireless signals 130 using antenna 140. In particular embodiments, network node 120 may comprise multiple antennas 140. For example, network node 120 may comprise a multi-input multi-output (MIMO) system with two, four, or eight antennas 140.

Wireless devices 110 may operate in full-duplex or half-duplex mode. In half-duplex mode, subframes of uplink wireless signal 130 and downlink wireless signal 135 do not overlap in time. When wireless device 110 switches between uplink and downlink (and vice versa), certain subframes are unused between uplink and downlink subframes to account for the switching interruption. In particular embodiments, the switching time may vary based on the round-trip time of a radio communication between wireless device 110 and network node 120. Round-trip time may depend on a distance between wireless device 110 and network node 120. For example, the round-trip time for a radio communication between wireless device 110a and network node 120 would typically be shorter than the round-trip time for a radio communication between wireless device 110b and network node 120 because wireless device 110a is closer than wireless device 110b to network node 120. The relationship between cell size, round-trip times, and switching times is described in more detail below.

In network 100, each radio network node 120 may use any suitable radio access technology, such as long term evolution (LTE), LTE-Advanced, UMTS, HSPA, GSM, cdma2000, WiMax, WiFi, and/or other suitable radio access technology. Network 100 may include any suitable combination of one or more radio access technologies. For purposes of example, various embodiments may be described within the context of certain radio access technologies. However, the scope of the disclosure is not limited to the examples and other embodiments could use different radio access technologies.

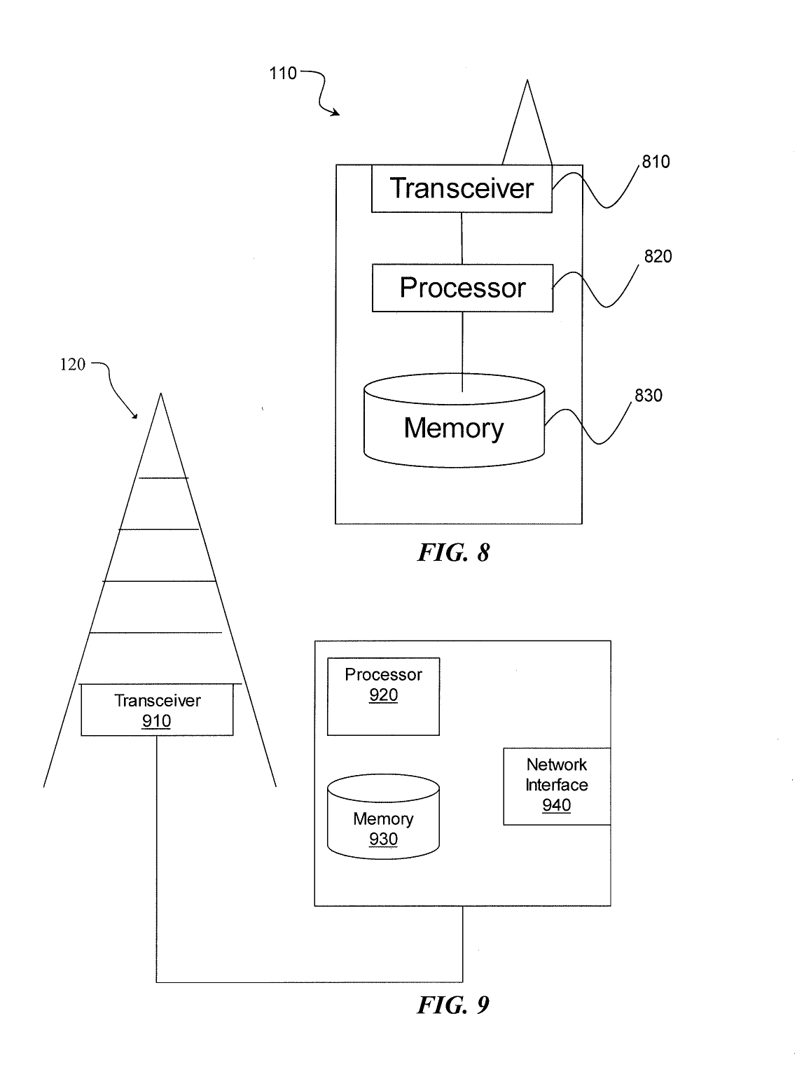

As described above, embodiments of a network may include one or more wireless devices and one or more different types of radio network nodes capable of communicating with the wireless devices. The network may also include any additional elements suitable to support communication between wireless devices or between a wireless device and another communication device (such as a landline telephone). A wireless device may include any suitable combination of hardware and/or software. For example, in particular embodiments, a wireless device, such as wireless device 110, may include the components described with respect to FIG. 8 below. Similarly, a radio network node may include any suitable combination of hardware and/or software. For example, in particular embodiments, a radio network node, such as radio network node 120, may include the components described with respect to FIG. 9 below.

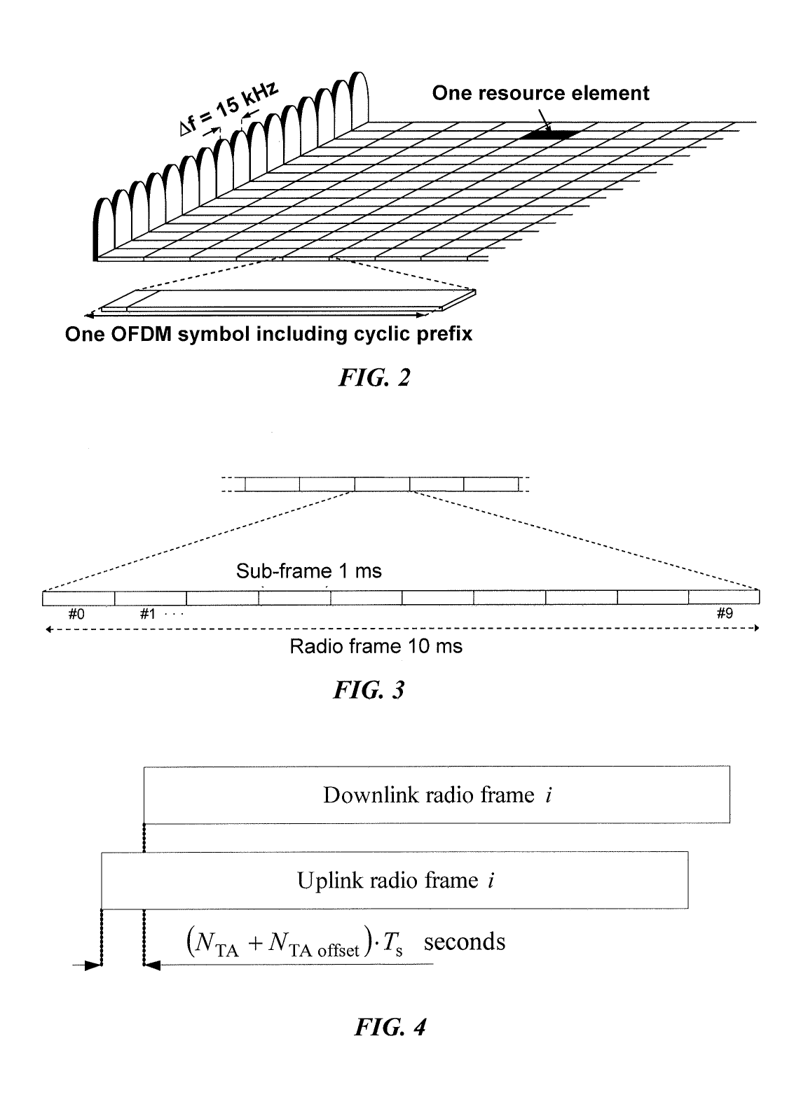

FIG. 2 illustrates an example OFDM symbol. LTE uses OFDM in the downlink where each downlink symbol may be referred to as an OFDM symbol. Furthermore, LTE uses Discrete Fourier Transform (DFT)-spread OFDM, also referred to as Single-Carrier FDMA (SC-FDMA), in the uplink, where each uplink symbol may be referred to as an SC-FDMA symbol. The basic LTE downlink physical resource may be illustrated as a time-frequency grid as shown in FIG. 2, where each resource element corresponds to one OFDM subcarrier during one OFDM symbol interval. In the time domain, LTE downlink transmissions may be organized into radio frames.

FIG. 3 illustrates an example radio frame. A radio frame is 10 ms and each radio frame consists of ten 1 ms subframes. Resource allocation in LTE may be described in terms of resource blocks (RBs), where a resource block corresponds to one slot (0.5 ms) in the time domain and twelve contiguous subcarriers in the frequency domain. A pair of two adjacent resource blocks in the time domain (1.0 ms) may be referred to as a resource block pair. Resource blocks may be numbered in the frequency domain, starting with 0 at one end of the system bandwidth. Each slot typically corresponds to seven OFDM symbols for downlink (SC-FDMA symbols for uplink) for normal cyclic prefix and six OFDM symbols for downlink (SC-FDMA symbols for uplink) for extended cyclic prefix.

LTE also includes the concept of virtual resource blocks (VRB) and physical resource blocks (PRB). The actual resource allocation to a UE is made in terms of VRB pairs. Resource allocations may be localized or distributed. Localized resource allocation directly maps a VRB pair to a PRB pair, hence two consecutive and localized VRB are also placed as consecutive PRBs in the frequency domain. Distributed VRBs are not mapped to consecutive PRBs in the frequency domain, which provides frequency diversity for data channels transmitted using distributed VRBs.

Downlink transmissions may be dynamically scheduled (i.e., in each subframe a base station transmits control information about which wireless devices will receive data and upon which resource blocks the data is transmitted). Downlink Control Information (DCI) may be carried by the Physical Downlink Control Channel (PDCCH). This control signaling may be transmitted in the first 1, 2, 3 or 4 OFDM symbols in each subframe, and the number n=1, 2, 3 or 4 may be referred to as the Control Format Indicator (CFI).

To preserve orthogonality in the uplink, the uplink transmissions from multiple UEs in LTE may be time aligned at an eNodeB receiver. This means that the transmit timing of UEs under the control of the same eNodeB should be adjusted to ensure that their received signals arrive at an eNodeB receiver at the same time, or more specifically their received signals should arrive well within the cyclic prefix (CP). Normal CP length may be about 4.7 μs. This enables an eNodeB receiver to use the same resources (i.e., same DFT or FFT resource) to receive and process signals from multiple UEs.

An eNodeB may maintain UL timing advance (TA) through timing advance commands (timing alignment commands) sent to a UE based on measurements of UL transmissions from the UE. For example, an eNodeB may measure two way propagation delay or round trip time for each UE to determine the value of the TA required for a particular UE.

Through TA commands, a UE is ordered to start its UL transmissions earlier or later depending upon its distance from its serving eNodeB. This may apply to all UL transmissions (including transmissions on PUSCH, PUCCH, and SRS) except for random access preamble transmissions on PRACH. For example, for a timing advance command received on subframe n, a UE may apply the corresponding adjustment of the uplink transmission timing from the beginning of subframe n+6. A timing advance command indicates a change of the uplink timing relative to the current uplink timing of the UE transmission as multiples of 16 Ts, where Ts=32.5 ns and is called basic time unit in LTE.

In case of random access response, an 11-bit timing advance command, T_{A}, for a timing advance group (TAG) indicates adjustment of N_{TA} values by index values of T_{A}=0, 1, 2, . . . , 1282, where an amount of the time alignment for the TAG is given by N_{TA}=T_{A}×16. N_{TA} is defined in the previous section above.

In other cases, a 6-bit timing advance command, T_{A}, for a TAG indicates adjustment of the current N_{TA} value, N_{TA,old}, to the new N_{TA} value, N_{TA,new}, by index values of T_{A}=0, 1, 2, . . . , 63, where N_{TA,new}=N_{TA,old}+(T_{A}−31)×16. Here, adjustment of the N_{TA} value by a positive or a negative amount indicates advancing or delaying the uplink transmission timing for the TAG by a given amount, respectively. An eNB may signal timing advance updates to the UE in MAC PDUs.

FIG. 4 illustrates an uplink-downlink timing relationship. Transmission of uplink radio frame number i from a UE, such as wireless device 110, may start (N_{TA}+N_{TA offset})×Tₛ seconds before the start of the corresponding downlink radio frame at the UE, where 0≦N_{TA}≦20512, N_{TA offset}=for frame structure type 1 (i.e., FDD) and N_{TA offset}=624 for frame structure type 2 (i.e., TDD).

Cell range, or more specifically maximum cell range (Rmax), may refer to a maximum possible distance between a UE, such as wireless device 110, and its serving eNodeB, such a network node 120. In LTE, the maximum cell range (e.g., cell size, cell radius, etc.) is typically limited to about 100 km. The reason is that the maximum UL transmit timing change can be up to 20512 Ts (i.e. 666640 ns), which is the round trip time or 2-way propagation delay. The delay corresponds to approximately 205 km of round trip distance. Therefore, the maximum distance between a UE and its serving eNodeB is about 100 km.

A wireless device, such as wireless device 110, may perform various timing related measurements. For example, the following timing related measurements may be performed by LTE radio nodes (e.g., by UE, eNodeB, or LMU):
UE Rx-Tx time difference (UE RTT);
eNB Rx-Tx time difference (eNodeB RTT);
Timing advance (T_{ADV}), which may be TA type 1 or TA type 2:
   T_{ADV1}=(eNB Rx-Tx time difference) +(UE Rx-Tx time difference);
   T_{ADV2}=(eNB Rx-Tx time difference);
One way or two way propagation delay between UE and base station;
Reference signal time difference (RSTD); and
UL Relative Time of Arrival (T_{UL-RTOA})
   One or more of these measurements may be used to determine a current distance (S) between a UE and its serving base station by the following relation: S=c×d; where c=3×10⁸ m/s (i.e., the speed of light in a vacuum) and d=one way propagation delay (in seconds) between a UE and its serving base station.

In LTE, a cell size can be as large as 100 km. However, in a typical deployment scenario the maximum cell size is smaller. For example, the cell range may be less than 3 km. Furthermore, even in larger cell sizes (e.g., cell range of 30 km or more), a UE may be close to its serving base station.

In HD-FDD operation, a UE switches between UL and DL subframes. A current assumption is that the switching time is 2 subframes (i.e., 2 ms). This time is derived by assuming 0.5 ms for frequency switching and about 0.7 ms for the 2-way propagation delay (or round trip time) of the largest cell range (up to 100 km). During the switching time (T0), a UE may not receive or transmit signals because its receiver and transmitter are not fully operational. This means, based on the current assumption in LTE HD-FDD operation, that 2 subframes may not be used by the UE or its network node for serving this UE when there is a transition between UL and DL subframes. This can amount to a significant loss of radio resources that a UE may not use for UL or DL transmission of radio signals (e.g., physical signals such as CRS, SRS, PRS etc., and physical channel such as PDSCH, PUSCH, etc.). The following embodiments describe methods that enable a UE and its network node to more efficiently use the radio resources by adaptively selecting a switching time based on one or more criteria and/or measurements.

Particular embodiments of the present disclosure may relate to adaptive uplink-downlink switching time for half-duplex operation in a wireless network. A wireless device and a network node may adaptively determine the switching time for switching between uplink and downlink time resources (e.g., UL-DL subframes) in half-duplex operation based on one or more parameters (e.g. criteria or measurements). The wireless device and the network node may use the adaptively determined switching time for performing switching between the UL and DL time resources. For example, a half-duplex capable UE served by a network node may obtain an adaptive switching time (T0) out of at least two values of switching times (T01 and T02) by comparing at least one parameter indicative of distance between the UE and the network node (e.g., propagation delay, signal measurement such as pathloss, relative location with respect to the network node, etc.) with a threshold (H) and use the obtained adaptive switching time for switching between UL and DL time resources in the transmission of UL and DL radio signals. A network node serving a half-duplex capable UE may obtain at least one parameter (e.g., threshold for comparing with propagation delay) related to an adaptive switching time (T0). The parameter may be a function of at least two values of switching times (T01 and T02), and the UE may use the parameter for determining the T0 for switching between UL and DL time resources. The network node may signal the obtained at least one parameter to the UE for enabling the UE to switch between UL and DL time resources in the transmission of UL and DL radio signals. Advantages of particular embodiments may include efficient use of available radio resources (e.g., UL and DL subframes) between a wireless device and a network node by adaptively selecting the switching time based on one or more criteria or measurements. A network node may be able to assign more radio resources for scheduling data transmission to a UE. A network node may have fewer constraints when scheduling data transmission to a UE because fewer radio resources may be wasted or may go unused when switching between UL and DL time resources.

Particular embodiments may overcome problems related to uplink-downlink switching time for half-duplex operation in wireless networks. While embodiments may be described by considering LTE, embodiments are applicable to any RAT or multi-RAT systems where the UE receives and/or transmit signals (e.g. LTE FDD/TDD, WCDMA/HSPA, GSM/GERAN, Wi Fi, WLAN, CDMA2000, etc.).

An example uplink-downlink switching scenario comprises at least one UE served by a cell (e.g., serving cell or PCell of the UE) that is managed, controlled, or served by a network node. The serving cell may operate on a carrier frequency (fl). The UE capable of multi-carrier (carrier aggregation) may also be served by a plurality of serving cells (e.g., primary cell (PCell) and one or more secondary cells (SCells)). The PCell and SCell(s) may be managed, controlled, or served by the same network node or by different network nodes. Embodiments described for one serving cell may also be applicable to a UE served by any number serving cells. In case of multiple serving cells, the UE and/or network node serving the UE may apply the procedures disclosed in these embodiments independently for each cell.

The UE operates in half-duplex where UL and DL transmission occur at different time resources (e.g., in different subframes). The UL and DL time resource may operate on the same or different carrier frequencies. In the latter case, the HD may be referred to as HD-FDD. The transition (switching) between UL and DL subframes is performed by a switching action. The transition may take place in either direction (i.e., from UL time resource to DL time resource or vice versa). Therefore, a generic term, “transition or switching between UL and DL time resource” may be used. The switching may apply to a UE that employs half-duplex operation. In LTE, HD-FDD operation typically is when a UE operates as HD-FDD and a base station operates as full-duplex FDD (FD-FDD). The switching may cause interruption because of the change in the frequency of operation and also because of the timing advance which depends upon the maximum cell range. Therefore, certain times (e.g., subframes) may be unused to account for switching between UL and DL subframes. These unused subframes are between UL and DL subframes. Switching between UL and DL subframes may be done dynamically (e.g., as frequent as after every UL or DL subframe). In this case, the switching is typically realized by scheduling (e.g., sending grant to the UE for UL or DL scheduling in PDCCH). Switching between UL and DL subframes may also be done on a static or semi-static basis. In this case the network node may configure a UE with a pattern of UL and DL subframes or a UE may use a pre-defined pattern of UL and DL subframes.

The terms switching time, HD switching time, HD-FDD switching time, switching delay, switching duration, switching period, guard time, guard period, transition time, transition duration, transition or switching between Rx and Tx, Rx-to-Tx or Tx-to-Rx transition or switch or guard time, or even unused time resources (e.g. subframe) due to switching, etc., may be interchangeably used, but they all refer to the same concept of switching between UL and DL time resources.

Particular embodiments may apply to any UE which is capable of HD operation or UE which is HD-FDD capable. Particular embodiments may apply to certain frequency bands supported by an HD capable UE or for all band supported by an HD capable UE.

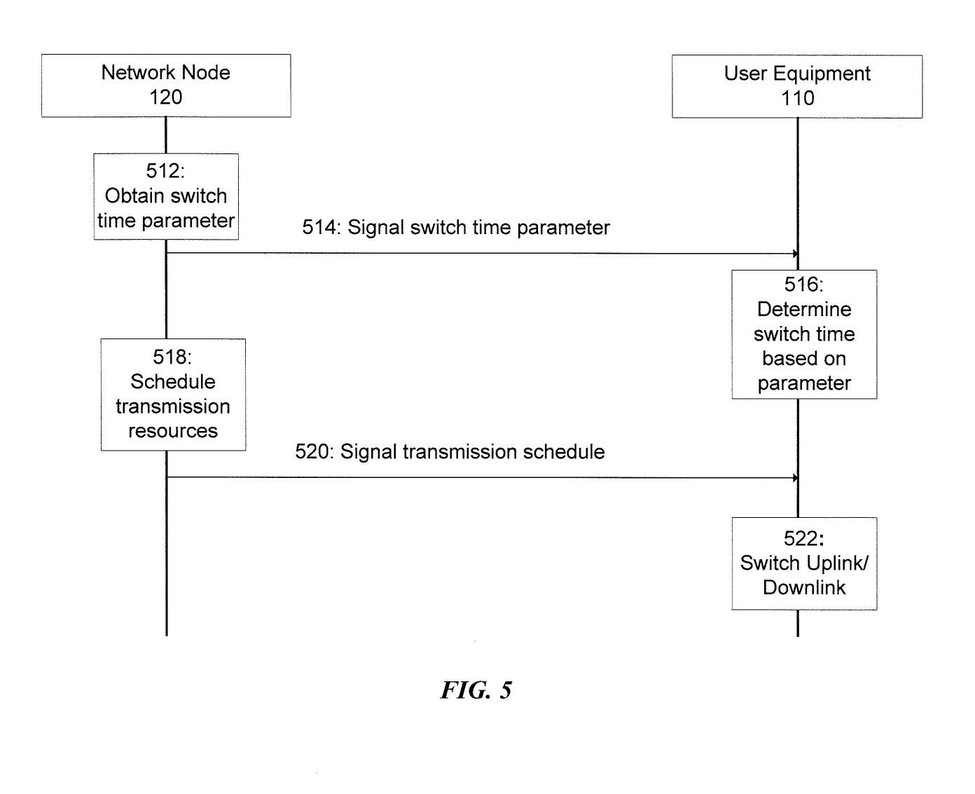

FIG. 5 is a signaling diagram of example signaling between a network node and a user equipment, according to some embodiments. In particular embodiments, one or more signaling steps may be performed by components of wireless network 100 described with reference to FIGS. 1-4 and 6-9.

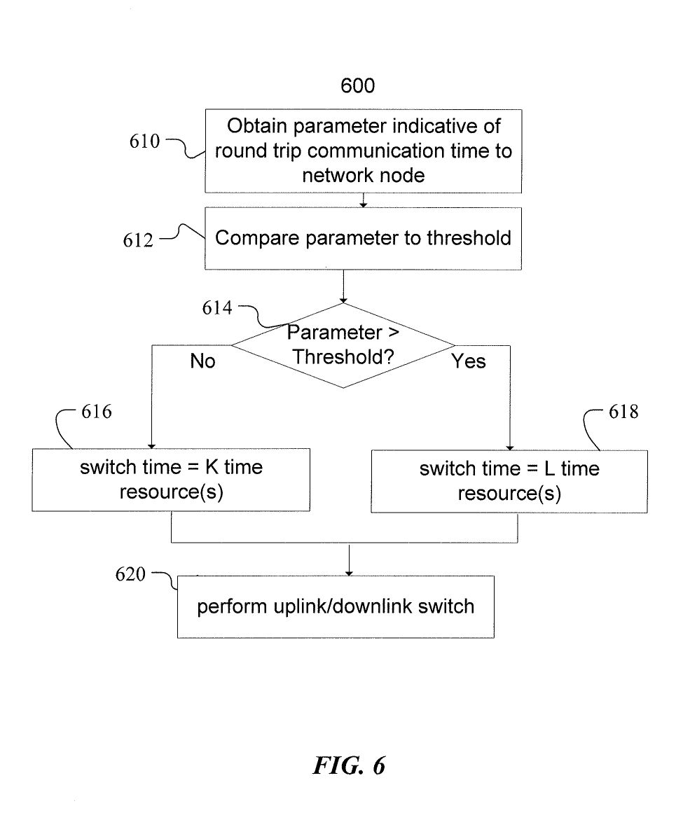

At step 512, a network node obtains a switch time parameter. In some embodiments, the switch time parameter may be a parameter indicative of a round trip time for a radio communication between the UE and the network node. In particular embodiments, the parameter indicative of a round trip time for a radio communication between the UE and the network node may be expressed as a unit of time, a number of radio resources in the time domain, a unit of distance, a radio signal strength measurement or any other suitable unit of measure. For example, network node 120 may implicitly or explicitly obtain information related to the switching time (T0) to be used by a wireless device 110 for switching between uplink and downlink time resources (i.e., UL-DL transition time). Switching time T0 is indicative of a round trip time for a radio communication between the UE and the network node because T0 may be higher for a UE with a longer round trip time than a UE with a shorter round trip time. In particular embodiments, the switch time parameter may comprise a distance between wireless device 110 and network node 120, a measurement of propagation delay between wireless device 110 and network node 120, or any other suitable parameter for determining an uplink/downlink switch time. Examples of particular steps for obtaining the switch time parameter are described in more detail below with respect to FIG. 6.

Based on the switch time parameter, network node 120 determines a switch time for wireless device 110. In particular embodiments, network node 120 may store the switch time associated with wireless device 110 for use in scheduling transmission resources.

The network node then signals the switch time parameter 514 to the wireless device. In particular embodiments, network node 120 may signal the switch time parameter obtained in step 512. In particular embodiments, network node 120 may signal an explicit number of time resources that wireless device 110 should use for uplink/downlink switching.

Signaling of switch time parameter 514 and any other associated conditions described below may be performed through any appropriate signaling method. For example, signaling may be accomplished using higher-layer signaling such as RRC signaling. Signaling may be part of physical layer control signaling, such as part of a DCI format. Signaling may be broadcast to all UEs in a cell, or through unicast signaling means.

At step 516, the wireless device determines its switching time based on the received switch time parameter. In particular embodiments, wireless device 110 may receive an explicit number of time resources that it should use for uplink/downlink switching. In particular embodiments, wireless device 110 may receive a parameter comprising a distance between wireless device 110 and network node 120, a measurement of propagation delay between wireless device 110 and network node 120, a threshold value related to distance or propagation delay, or any other suitable parameter for determining an uplink/downlink switch time. Based on the received parameter, wireless device 110 may determine its switching time. For example, wireless device 110 may receive a threshold value of 75 kilometers. If wireless device 110 determines it is less than 75 kilometers from network node 120, wireless device 110 may use one subframe for its switching time. If wireless device determines it is more than 75 kilometers from network node 120, wireless device 110 may use two subframes for its switching time.

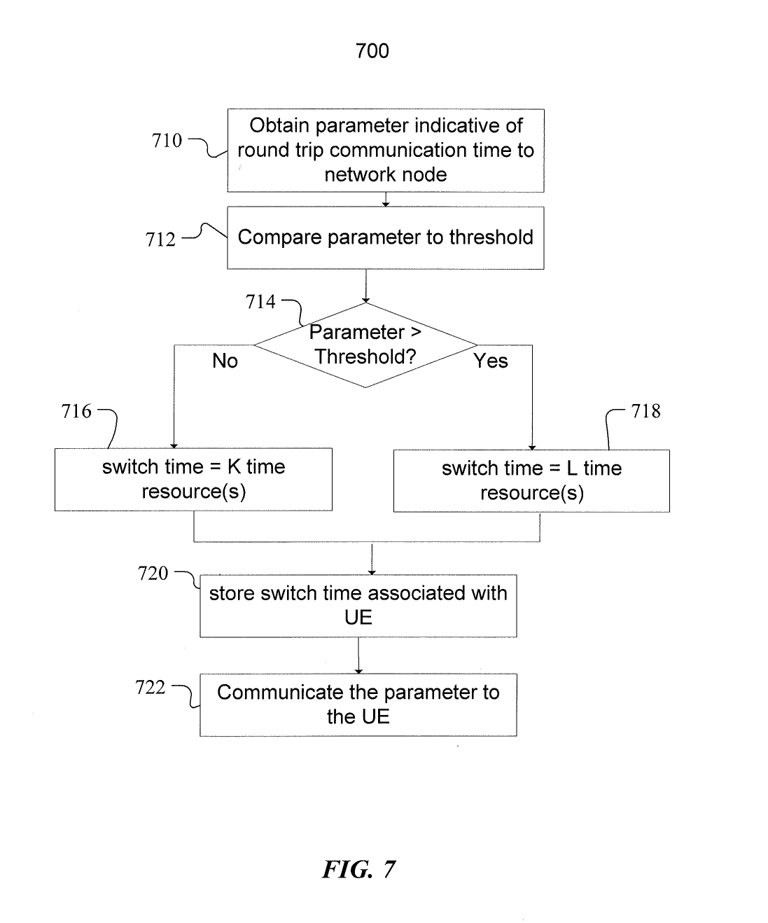

In particular embodiments, wireless device 110 may autonomously obtain the information needed to determine its uplink/downlink switch time. In such embodiments, network node 120 and wireless device 110 may each determine the uplink/downlink switch time independently, and signaling of switch time parameter 514 may be optional. Examples of particular steps for obtaining a switch time parameter and determining a switch time are described in more detail below with respect to FIG. 7.

At step 518, the network node schedules transmission resources. In particular embodiments, network node 120 may determine scheduling resources based at least in part on uplink/downlink switch times for one or more wireless devices 110 in network 100. For example, a transmission schedule may take into account that wireless device 110a may use a single subframe for uplink/downlink switching and that wireless device 110b may use two subframes.

The network node signals transmission schedule 520 to the wireless device. For example, wireless device 110 may receive its transmission schedule from network node 120. Based on the transmission schedule, wireless device 110 may determine which time resources it may use for uplink and downlink.

At step 522, the wireless device switches between uplink and downlink (or vice versa). For example, wireless device 110 may switch its radio resources from a transmit to receive configuration. Wireless device 110 may change the frequency of its local oscillator to facilitate transmit/receive on a different frequency.

Modifications, additions, or omissions may be made to the signaling illustrated in FIG. 5. Additionally, one or more steps may be performed in parallel or in any suitable order.

FIG. 6 is a flow diagram of a method in a user equipment of performing an uplink/downlink switch, according to particular embodiments. In particular embodiments, one or more steps of method 600 may be performed by components of wireless network 100 described with reference to FIGS. 1-5 and 7-9.

According to one embodiment, a UE obtains and applies adaptive switching time for UL-DL time resource switching. A UE may implicitly or explicitly obtain information related to the switching time (T0) for switching between UL and DL time resources (UL-DL transition time); use the obtained information to determine the switching time; and use the determined switching time for performing the switch or transition between UL and DL time resource. A summary of example steps performed by a UE include obtaining information related to switching time; determining switching time based on obtained information; and switching between UL and DL time resources based on determined switching time. Additional or optional steps performed by a UE may include adapting measurement sampling accounting for adaptive switching time.

At step 610, the wireless device obtains a parameter indicative of a round trip time for a radio communication between the wireless device and the network node. For example, a UE, such a wireless device 110, obtains implicit or explicit information that can be used for determining the switching time (T0) to be assumed or used by the UE for switching between UL and DL time resources. The UE may use one or more parts of the obtained information for determining T0. Examples of implicit information include:
current physical distance between the UE and its serving network node;
UE speed or velocity (e.g., UE speed expressed in Doppler (such as 30 Hz) or rate of change of distance (such as 50 km/hr));
cell size of the serving cell or maximum distance between base station and cell edge (e.g., cell range, cell radius);
power class of the serving base station (e.g., maximum power of the BS such as 46 dBm, 30 dBm, 24 dBm, 20 dBm, etc.);
type of serving base station (e.g., wide area BS, medium range BS, local area base station, home base station, etc.);
type of cell topology or cell deployment type (e.g., macro cell, micro cell, pico cell, femto cell, etc.);
configured maximum UE transmit power (e.g., a power level below 0 dBm refers to a smaller cell and therefore a smaller switching time, such as 1 ms, may be used);
value of the last timing advance command (TA) obtained by the UE;
amount of timing adjustment (ΔT) to be applied by the UE for transmitting the next UL signal (e.g., PUCCH, PUSCH, SRS, etc.), where ΔT is to be applied by the UE with respect to the corresponding (e.g., next) DL radio frame timing detected at the UE;
one way propagation delay between the UE and the serving network node;
two way propagation delay (e.g., round trip time) between the UE and the serving network node;
UE Rx-Tx time difference measurement performed by the UE;
eNodeB Rx-Tx time difference measurement performed by the network node;
signal strength measurements, such as those between the UE and the network node (e.g., path loss, RSRP, etc.), obtained from the UE;
signal quality measurements, such as those between the UE and the network node (e.g., RSRQ, SINR, SNR, BLER, etc.), obtained from the UE or based on UE feedback signals such as CAN/NACK; and
known position or geographical location of UE and network node. Their positions may be determined by using one or more positioning methods. Examples include GNSS/A-GNSS (e.g., GPS or A-GPS), OTDOA based RSTD measurements, E-CID, radio fingerprinting or any other known cellular positioning technology from which relative round trip delay between the UE and the network node may be calculated.
   Examples of explicit information include:
duration of switching time (e.g., 2 ms); and
number of consecutive time resources over which switching is to be done or to be used for switching (e.g., 2 subframes).

In the examples listed above, the parameter indicative of a round trip time for a radio communication between the UE and the network node includes parameters expressed as a unit of time, a number of radio resources in the time domain, a unit of distance, a geographical location, a radio signal strength or quality measurement, and other suitable units. As an example, a radio signal strength measurement may indicate a distance between the UE and the network node and that distance may determine a round trip time for a radio communication between the two. One of ordinary skill in the art would understand that the parameter indicative of a round trip time for a radio communication between the UE and the network node may be represented by any suitable unit of measurement.

In particular embodiments, the above obtained implicit or explicit information may be valid for each transition between UL and DL time resources or it may be applicable over certain validity time (ΔT1) (e.g., ΔT1=500 ms). Here, the parameter is similar to N_{TA} described above with respect to timing advance. In particular embodiments, the parameter ΔT1 may be applicable from a reference time (T1), where T1 can be the time instant at which the UE obtains the parameter ΔT1 or it may apply from the time instance when the UE performs first transition between UL and DL subframes.

In particular embodiments, any of the above information (e.g. implicit or explicit information or their validity time) may be obtained by the UE by one or more of the following means:
autonomously by the UE (e.g., based on radio measurements);
receiving from the network node (e.g., via higher layer signaling such as the serving network node signaling the switching time to be used);
receiving from another UE if the UE is capable of performing device to device (D2D) operation and the other D2D UE has any of this information (e.g., it acquired from the network node); and
pre-defined information (e.g., two or more pre-defined switching times such as T01=1 subframe and T02=2 subframes).

At step 612, the wireless device compares the obtained parameter to a threshold. In particular embodiments, such as when the obtained parameter is an explicit switch time value (e.g., 1 ms or 1 subframe), comparison to a threshold may be optional or the comparison may comprise validating that the explicit value is a valid value, or is in a valid range of values. In some embodiments, comparison to a threshold may comprise evaluating a function that may include one or more thresholds. In particular embodiments, comparison to a threshold may include any suitable method of evaluating the obtained parameter to determine an uplink/downlink switching time. In some embodiments, the wireless device determines the threshold autonomously. In some embodiments, the wireless device receives the threshold from the network node.

In some embodiments, a UE, such as wireless device 110, determines the switching time based on comparing the obtained information with a threshold. The UE determines the actual switching time to be used by the UE when performing transition between UL and DL time resources.

If the UE obtains a value of the switching time (e.g., 1 ms or 1 subframe) explicitly from the network node, then it may apply the obtained value for at least one transition between UL and DL time resources. If the UE obtains any implicit information for determining the switching time, then the UE may use the obtained information and also one or more pre-defined information for determining the actual value of the switching time.

In some embodiments, the determination at the UE may be done by comparing the obtained information with one or more thresholds (H) and selecting one of the two or more predefined values of the switching times. The threshold(s) may be pre-defined or received from the network node (e.g., via higher layer signaling such as via RRC or MAC).

In some embodiments, the determination of the switching time (T0) may be based on a function. An example of a general function may be: T0=f(T01, T02, . . . T0ᵢ, P1, P2, . . . Pj, H1, H2, . . . Hⱼ), where T0i is one of the pre-defined switching times, parameter Pi is one of the parameters (e.g., propagation delay), and Hi is the threshold to compare the parameter Pi. This generalized function is described in relation to various examples below.

In some embodiments, the relation or mapping between the comparison of the one or more obtained parameters with their respective obtained threshold(s) and the corresponding switching time to be selected based on comparison by the UE can be pre-defined. In one example, the UE may obtain one or more parameters that implicitly or explicitly indicate the distance (S) between the UE and network node and use them for determining one of the two possible values of switching times. This example is represented in Table 1 below.

For example, the parameter may be related to propagation delay between UE and network node such as a round trip time, timing advance command, one or two way propagation delay, amount of UL transmit timing adjustment (ΔT) with respect to DL frame timing to be applied by the UE (e.g., derived by UE from obtained TA), UE Rx-Tx time difference, or eNodeB Rx-Tx time difference measurements. The threshold (H) to be used by the UE may also correspond to the type of the obtained parameter. The UE then compares the value of the obtained parameter (P) with a least one threshold (H). The UE then selects, at step 616 or 618, one of the two or more switching times based on the outcome of the comparison operation.

Table 1 represents selecting one of the two possible switching times based on one threshold value. In a specific example, the P and threshold (H) can be 2-way propagation delay and 0.5 ms respectively. Further, assume that as a special case the two pre-defined switching times can be 1 and 2 subframes (i.e., in this particular example, K time resource is one subframe and L time resource is two subframes). This means the UE will assume switching time of 1 ms for performing UL-DL transition if the obtained 2-way propagation delay (D) is not more than 0.5 ms, which corresponds to distance between UE and base station (S) of 75 km. But if the propagation delay (D) is more than 0.5 ms, then the UE assumes and uses switching time of 2 subframes for performing UL-DL transition. In other words, when D is small or medium, or when the UE operates in a cell of smaller or medium range, then the switching time is shorter. But when the UE operates in a cell of larger range (e.g., more than 75 km), then the switching time is longer. During the switching time, the UE may not transmit or receive radio signals. Another variation of this example is shown in Table 1A, where the equality sign differs for different switching times.

In another example, the UE may obtain one or more parameters that implicitly or explicitly indicate the distance between the UE and network node and use them for determining one of the three possible values of switching times. This example is represented by Table 2. This example is similar to the example represented by Table 1, except that in this example the UE may use up to two threshold values (H1 and H2) for comparing it with the obtained parameter (P) that is implicitly or explicitly indicative of the distance (S). As a particular example, the values of K, L and M time resources can be 1 subframe, 2 subframes and 3 subframes, respectively, and the thresholds H1 and H2 related to the 2-way propagation delay can be 0.3 ms and 0.5 ms, respectively. This means for S up to 25 km the UE uses 1 subframe, for S between 25 and 75 km the UE uses 2 subframes, and for S larger than 75 km the UE uses 3 subframes for performing transition between UL and DL subframes in this example. Table 2A represents another variation of this example where the equality sign differs for different switching times.

In another example, represented by Table 3, the UE may obtain one or more parameters that implicitly or explicitly indicate the distance between the UE and network node and use them for determining one of the ‘n’ possible values of switching times. This example is similar to the previous examples in Tables 1 and 2 except that in this example the UE may use up to (n−1) threshold values (H1, H2 . . . Hn−1) for comparing it with the obtained parameter (P) that is implicitly or explicitly indicative of the distance (S). Based on this comparison, the UE determines one of the n switching times and uses it for performing the switching between UL and DL time resources. Table 3A represents another variation of this example where the equality sign differs for different switching times.

TABLE 1
Example determination of one of the two
pre-defined switching times by the UE

| | Determination of switching time by UE | |
|---|---|---|
| Switching | Result of comparing parameter | Determined switching |
| time ID | (P) with threshold (H) | time (T0) |
| 0 | P ≦ H | K time resource |
| 1 | P > H | L time resource |

TABLE 1A
Example determination of one of the two
pre-defined switching times by the UE

| | Determination of switching time by UE | |
|---|---|---|
| Switching | Result of comparing parameter | Determined switching |
| time ID | (P) with threshold (H) | time (T0) |
| 0 | P < H | K time resource |
| 1 | P ≧ H | L time resource |

TABLE 2
Example determination of one of the three
pre-defined switching times by the UE

| | Determination of switching time by UE | |
|---|---|---|
| | Result of comparing parameter | |
| Switching | (P) with up to 2 thresholds | Determined switching |
| time ID | (H1, H2) | time (T0) |
| 0 | P ≦ H1 | K time resource |
| 1 | H1 < P ≦ H2 | L time resource |
| 2 | P > H2 | M time resource |

TABLE 2A
Example determination of one of the three
pre-defined switching times by the UE

| | Determination of switching time by UE | |
|---|---|---|
| | Result of comparing parameter | |
| Switching | (P) with up to 2 thresholds | Determined switching |
| time ID | (H1, H2) | time (T0) |
| 0 | P < H1 | K time resource |
| 1 | H1 ≦ P < H2 | L time resource |
| 2 | P ≧ H2 | M time resource |

TABLE 3
Example determination of one of the ‘n’
pre-defined switching times by the UE

| | Determination of switching time by UE | |
|---|---|---|
| | Result of comparing parameter | |
| Switching | (P) with up to n−1 thresholds | Determined switching |
| time ID | (H1 . . . , Hn−1) | time (T0) |
| 0 | P ≦ H1 | K1 time resource |
| 1 | H1 < P ≦ H2 | K2 time resources |
| . . . | . . . | . . . |
| n−1 | P > Hn−1 | Kn time resources |

TABLE 3A
Example determination of one of the ‘n’
pre-defined switching times by the UE

| | Determination of switching time by UE | |
|---|---|---|
| | Result of comparing parameter | |
| Switching | (P) with up to n−1 thresholds | Determined switching |
| time ID | (H1 . . . , Hn−1) | time (T0) |
| 0 | P < H1 | K1 time resource |
| 1 | H1 ≦ P < H2 | K2 time resources |
| . . . | . . . | . . . |
| n−1 | P ≧ Hn−1 | Kn time resources |

In some embodiments, if the UE is not able to obtain the needed information related to switching time (e.g., during an initialization phase), the UE may adopt a predefined default value until it is able to obtain the needed information. It may also be pre-defined that the UE will assume a pre-defined value for switching time in case it does not obtain the switching time or associated information to derive or obtain the switching time. As an example, the pre-defined default value of switching time can be 1 subframe. In another example, the pre-defined default value can be the smallest of the pre-defined values.

In some embodiments, the UE applies a hysteresis in the comparison between a parameter value and a threshold in order to avoid unnecessarily frequent changes between different switching times (e.g., due to statistical fluctuations in measurement values).

At step 620, the wireless device performs the uplink/downlink switch. In particular embodiments, a UE, such as wireless device 110, performs the next UL-DL switching by assuming the acquired switching time as further elaborated below. The term acquiring herein may refer to any of receiving, acquiring, determining, selecting, retrieving or obtaining the switching time or associated information (such as scheduling). The acquiring may be performed autonomously, based on a pre-defined rule, or received from another node (e.g., UE or a network node). The UE may also retrieve from its memory the switching time acquired previously or at any earlier time. In this case, the UE may also determine whether the retrieved switching time is applicable for switching between UL and DL time resources.

For example, the UE may determine whether the validity time for using the retrieved or acquired switching time is still valid (e.g., validity timer (e.g. 500 ms) has not yet expired). The value of the timer may also be adapted based on UE speed (e.g., shorter value of the timer at higher UE speed (such as above 50 km/hr)).

In particular embodiments, the UE may acquire the information related to the next switching between UL and DL time resources to be performed and/or the pattern of such switching applicable over certain time period (e.g., frame or multiple frames or periodic pattern, etc.). The UE may acquire this information based on any one or more of:
scheduling data on UL and/or DL time resources by the network node;
semi-static or semi-persistent scheduling pattern for physical signals or channels configured by the network node; and
any kind of periodic or aperiodic pattern of scheduling of data on UL and DL time resources by the network node.

If the acquired switching time is valid, then the UE may use the acquired information related to the transition between UL and DL time resource for performing at least the next switching between UL and DL time resources. The UE may also store the statistics related to the switching times used for performing the switching and use it in future time (e.g., for reporting the statistics to the network node.)

Modifications, additions, or omissions may be made to method 600. Additionally, one or more steps in method 600 of FIG. 6 may be performed in parallel or in any suitable order. For example, an optional step (not illustrated) in particular embodiments may include adapting measurement sampling accounting for adaptive switching time.

For example, the UE may perform one or more radio measurements on UL and/or DL radio signals (e.g., RSRP, RSRQ, timing measurements, etc.) in one or more UL and/or DL subframes during a frame. The UE may not perform measurements in unused subframes which are lost due to switching between UL and DL subframes. The UE may take into account the adaptive switching time currently used for the switching, for also adapting its measurement procedure of one or more measurements. Examples of adapting measurement procedure include adapting the measurement sampling, which in turn may mean the frequency of the sample, adapting the size of the sample, and adapting the duration over which the samples are obtained. For example, if the switching time is longer (e.g., 2 subframes or more), then the UE will miss more subframes for measurements. In this example, the UE may perform the measurement by extending the measurement time (e.g., from 200 ms to 400 ms). But if the switching time is shorter (e.g., 1 ms), then the UE may perform the measurement over the default or shorter time (e.g., 200 ms). This may ensure that the UE is able to perform the same measurement by achieving the same performance (e.g., the same measurement accuracy) regardless of the switching time (used for one or more actions of switching between UL and DL subframes) during the measurement time.

FIG. 7 is a flow diagram of a method in a network node of communicating a parameter for uplink/downlink switching to a user equipment, according to particular embodiments. In particular embodiments, one or more steps of method 700 may be performed by components of wireless network 100 described with reference to FIGS. 1-6 and 8-9.

According to one embodiment, a network node determines and configures a UE with an adaptive switching time for enabling UL-DL time resource switching. The network node may implicitly or explicitly obtain information related to the switching time (T0) to be used by the UE for switching between UL and DL time resources (UL-DL transition time) and transmit the obtained information to the UE enabling the UE to perform the switch or transition between UL and DL time resource. The network node may also configure the UE with information which allows the UE to determine when to perform the switching between UL and DL time resources.

A summary of example steps performed by the network node may include obtaining information related to switching time and signaling information to assist switching based on obtained information. Additional or optional steps performed by a network node may include configuring a UE with UL and/or DL time resources.

At step 710, a network node obtains a parameter indicative of round trip time for a radio communication between a wireless device and the network node. For example, a network node, such as network node 120, obtains information related to switching time. The network node determines the switching time (T0) to be used by the UE for switching between UL and DL time resources.

Examples of information the network node may use to determine which switching time should be used by the UE or any implicit information to be used by the UE for determining the switching time to be used the network node include:
current physical distance between the UE and the serving network node;
cell size of the serving cell or maximum distance between base station and cell edge (e.g., cell range, cell radius);
power class of the serving base station (e.g., maximum power of the BS such as 46 dBm, 30 dBm, 24 dBm, 20 dBm, etc.);
type of serving base station (e.g., wide area BS, medium range BS, local area base station, home base station, etc.);
type of cell topology or cell deployment type (e.g., macro cell, micro cell, pico cell, femto cell, etc.);
value of the last timing advance command (TA) sent or to be sent to the UE;
amount of timing adjustment (ΔT) to be applied by the UE for transmitting the next UL signal (e.g., PUCCH, PUSCH, SRS, etc.), where ΔT is to be applied by the UE with respect to the corresponding (e.g., next) DL radio frame timing detected at the UE;
one way propagation delay between the UE and the serving network node;
two way propagation delay (e.g., round trip time) between the UE and the serving network node;
UE Rx-Tx time difference measurement performed by the UE and reported by the UE to the network node; and
eNodeB Rx-Tx time difference measurement performed by the network node.

Depending upon the type of the information, the network node may obtain the above information based on any one or more of the following:
measurement performed by the network node itself on at least the signals transmitted by the UE (e.g., propagation delay, eNodeB Rx-Tx time difference, TA, etc.);
pre-defined information (e.g., cell size, power class of BS, cell topology, etc.); and
measurement performed by the UE (e.g., UE Rx-Tx time difference, etc.), which are obtained from the UE or from any other node that has this measurement.

While the examples listed above express the parameter indicative of a round trip time for a radio communication between the UE and the network node in terms of particular units, one of ordinary skill in the art would understand that the parameter may be represented by any suitable unit of measurement.

At step 712, the network node compares the obtained parameter to a threshold. In particular embodiments, such as when the obtained parameter is an explicit switch time value (e.g., 1 ms or 1 subframe), comparison to a threshold may be optional or the comparison may comprise validating that the explicit value is a valid value, or in a valid range of values. In some embodiments, comparison to a threshold may comprise evaluating a function that may include one or more thresholds. In particular embodiments, comparison to a threshold may include any suitable method of evaluating the obtained parameter to determine an uplink/downlink switching time.

In some embodiments, a network node, such as network node 120, may determine the switching time to be used by the UE based on the above information at step 716 or 718. The network node may also determine the threshold value to be used by the UE for determining the switching time based on a comparison between one or more parameters (P) which is indicative of the distance between UE and serving network node (S) and the respective thresholds (H) (as described in a previous embodiment).

The network node may use similar comparison between one or more parameters (P) and thresholds (H) as used by the UE (as described in a previous embodiment) for determining the switching time. Therefore, examples in Tables 1, 2 and 3 are also applicable for use by the network node. For example, if cell size is small or medium (e.g., 75 km or less), then the network node may determine that the UE should use a shorter switching time (e.g., 1 subframe). In another example, if the BS power class or maximum BS power is 43 dBm or higher, then the network node may decide that UE uses longer switching time (e.g., 2 subframes).

At step 720, the network node stores the switch time associated with the wireless device. For example, in particular embodiments network node 120 may store the switch time associated with one or more wireless devices 110 of network 100 for use in scheduling transmission resources.

At step 722, the network node communicates the parameter to the wireless device. For example, in particular embodiments network node 120 signals information to assist switching based on obtained information. Upon determining the switching time to be used by the UE, the network node may signal one or more pieces of information to the UE that assists the UE to use or itself determine the switching time for switching between UL and DL radio resources. The network node may or may not signal the determined switching time to the UE. If the network node signals the switching time to the UE, then it may signal either the absolute value of the switching time (e.g., 1 ms or 1 subframe) or it may signal only the identifier of the determined switching time. In the latter case, both identifiers and the corresponding switching time can be pre-defined, as shown in Tables 1-3. For example, the network node may also decide to signal only the threshold(s) to be used by the UE for comparing P with H to obtain the switching time.

As a particular example, the network node may signal a threshold distance of 75 km to the UE. The UE may autonomously determine its distance from the network node and compare the determined distance with the threshold value to determine its switch time (e.g., switch time is one subframe if the determined distance is less than 75 km).

In some embodiments, the network node may signal both a parameter and a threshold to the UE. For example, the network node may signal a threshold distance of 75 km to the UE. The network node may periodically signal a parameter to the UE representing the distance between the UE and the network node. The UE may compare the parameter with the threshold to determine its switch time. At some later time the network node may determine a new threshold value, such as 65 km, and signal the new threshold value to the UE. The UE may use the new threshold for comparison with the received distance parameter.

In particular embodiments, when the network node signals the determined switching time, the UE may use it for performing switching. If the network node signals implicit information to the UE, such as thresholds and/or type of parameters (e.g., propagation delay, UE Rx-Tx time difference, etc.), to be used by the UE for determining the switching time, then the UE uses the received information and the pre-defined relations for determining the switching time (as described in a previous embodiment).

In another example, the network node may also signal information related to the validity time over which the signaled parameters or associated information is valid. This can be realized by configuring a timer at the UE. For example, the UE can be configured that the information related to the switching time is valid for use by the UE up to 500 ms from the moment the information is received at the UE. In another example, it may be pre-defined or configured by the network node at the UE that the information related to the switching time is valid for performing up to Z (e.g., Z=1, Z=10, etc.) number of transitions between UL-DL time resources.

Any one or more of the above information may be provided to the UE using higher layer signaling (e.g., RRC, MAC, etc.) or in lower layer signaling (e.g., L1 channels such as PDCCH, etc.). The information may also be signaled as part of the scheduling information.

In particular embodiments, the network node (transmitting network node) may signal one or more set of the above information related to one or plurality of the UEs to another network node (receiving network node), such as a neighboring eNodeB over X2 interface. The receiving network node may use the received information for determining one or more parameters related to the switching time to be used for its own UEs and/or the received information be used for the UEs after their cell change from the transmitting network node.

In some embodiments, if the network node is not able to signal the information to assist switching to the UE (e.g., during an initialization phase), the network node may assume that the UE is applying a predefined default value until it is able to obtain the assistance information from the network. It may also be pre-defined that the UE will assume a pre-defined value for switching time when it does not obtain the switching time or associated information to drive or obtain the switching time. As an example, the pre-defined default value of switching time can be 1 subframe. In another example, the pre-defined default value can be the smallest of the pre-defined values. The network may, in such a situation, determine the switching time based on the pre-defined rule and adapt its scheduling (as described further below).

In some embodiments, the network applies a hysteresis in the comparison between a parameter value and a threshold in order to avoid unnecessarily frequent changes between different switching times (e.g., because of statistical fluctuations in measurement values).

Modifications, additions, or omissions may be made to method 700. Additionally, one or more steps in method 700 of FIG. 7 may be performed in parallel or in any suitable order. For example, step 720 may be omitted. As another example, an optional step (not illustrated) in particular embodiments may include configuring the UE with UL and DL time resources.

For example, the network node may schedule the data for UL transmission and DL transmission on UL time resource and DL time resource respectively. The scheduling can be done on subframe basis (e.g., sending scheduling grant on the PDCCH). The network node may also pre-configure the UE with a pattern of UL and DL time resources for UL and DL transmissions respectively. The scheduling information acquired by the UE may be used by the UE for switching between UL and DL time resources whenever the successive time resources are for transmission in opposite direction. In particular embodiments, the UE accordingly uses the determined switching time for performing the switching between the UL and DL time resources.

The UE may not transmit or receive radio signals during the switching time. The network node, therefore, considers the switching time to be unused time. In some embodiments, the network node adapts it's scheduling to account for the currently used switching time for switching between UL and DL time resources (adaptive scheduling based on UL-DL switching time). For example, if the switching time is K time resource (e.g., 1 subframe), then the network node does not schedule the UE over K time resource (e.g., 1 subframe); but if the switching time is L time resource (e.g., 2 subframes), then the network node does not schedule the UE over L time resource (e.g., 2 subframes). To compensate the unscheduled data due to longer switching time (e.g., 2 subframes), the network node may assign more scheduling resources to the UE.

According to one embodiment, a UE signals capability related to obtaining and applying adaptive switching time for UL-DL time resource switching. A UE signals a capability information to another node (a network node such as base station, eNodeB, relay, core network (MME), another UE capable of D2D operation, etc.) to inform whether the UE is capable of acquiring and using or applying information related to the switching time for switching between UL and DL time resources.

The UE capability information may indicate whether the UE is capable of obtaining and using adaptive switching time for switching between UL and DL time resources, wherein the adaptation may be done by selecting between at least two values of switching times (e.g., 1 subframe and 2 subframes). The UE may indicate whether it has the capability to obtain one or more parameters related to the switching time, use them to determine the switching time, and use the determined switching time for switching between UL and DL time resources (i.e., whether the UE is capable of any of the procedures disclosed in the embodiments described above). The capability information may be sent via higher layer signaling (e.g., RRC signaling) to the network node. The information may be sent during initial call setup, after cell change (e.g., handover, etc.), or during the session or call.

The UE capability information may include:
whether the UE is capable of autonomously determining the adaptive switching time (e.g., based on pre-defined parameters and/or rules) and using the determined switching time for switching;
whether the UE is capable of determining the adaptive switching time based on information received from the network node (e.g., threshold for comparing with the determined parameter to find the switching time) and using the determined switching time for switching;
whether the UE is capable of determining the adaptive switching time based on any combination of information received from the network node and/or another UE, pre-defined parameters and/or rules, and autonomous determination by the UE, and using the determined switching time for doing switching; and
the frequency bands for which the UE is capable of performing any one or more of the above.

The acquired UE capability information may be used by the network node (e.g., eNodeB, base station, etc.) for performing one or more radio operation tasks or network management tasks, including:
forwarding the received UE capability information to another network node which may use it after cell change of the UE
storing the received capability information and using it in the future (e.g., when the same UE performs switching or returns to be served by the network node); and
deciding, based on the received information, whether to configure or signal any information related to the switching time or any information which may assist the UE in determining or using the switching time—for example, if the UE needs to receive the switching time as it cannot determine it autonomously, then the network node itself may determine the switching time and signal the determined value to the UE.

A particular embodiment may be implemented within the framework of a 3GPP TSG RAN standard. The described embodiment is merely intended to illustrate how certain aspects of the proposed solutions could be implemented in a particular standard. However, the proposed solutions could also be implemented in other suitable manners, both in the 3GPP Specification and in other specifications or standards.

For example, a low complexity UE category for MTC application may be specified for all duplex modes including half-duplex FDD mode. UL/DL switching for HD-FDD operation may be assumed to be handled as specified in Section 6.2.5 of TS 36.211 (from Rel-8 onwards) also for low complexity MTC UEs when operating with/without coverage enhancement. An example specification may identify what switching time would be expected from Rx to Tx and Tx to Rx for the MTC UE category when operating in half-duplex FDD mode.

An example implementation may include margin for Rx-to-Tx and Tx-to-Rx switching time expected for support of half-duplex FDD operation for low complexity MTC UEs to be nominally 1 subframe total for Rx-to-Tx and Tx-to-Rx switching and back. The margin may apply for cell sizes of less than 75 km. For cell ranges of greater than 75 km, 2 subframes may be impacted.

In particular embodiments, the switching time accommodates both the round trip propagation delay as well as the physical switching time between Tx and Rx. For example, an example implementation may specify particular factors for a HD-FDD guard period. For switching from RX to TX, an implementation may specify the round trip time may be up to a maximum of 667 us as the maximum E-UTRAN cell coverage and specify a particular number of microseconds to switch from OFF to ON (including oscillator adjustment time). For switching from TX to RX, an implementation may specify a particular number of microseconds to switch from ON to OFF (including oscillator adjustment time).

In a particular HD-FDD implementation of an MTC UE, one of the contributors to the TX-to-RX and RX-to-TX switching time is the settling time of the phase lock loop (PLL) in the MTC UE transceiver. The use case for which the TX-to-RX or RX-to-TX switching is at the same frequency will have the lowest latency and furthermore if there are valid TX or RX settings available such that updates to existing control loops in the RX AGC are unnecessary, then the switching time can be relatively fast.

However, for a HD-FDD MTC UE a wireless device will need to switch between the transmit and receive frequencies and allow the PLL to settle to a defined accuracy. An MTC transceiver with two PLLs, one for the TX chain and the second for the RX chain, may avoid certain disadvantages at a high cost. To implement a low cost MTC UE, however, a particular MTC UE may include a single PLL. For a HD-FDD implementation of an MTC UE, this single PLL will need to switch frequencies and settle to an agreed accuracy of frequency stability. In order to reach a typical LTE frequency stability of 0.1 ppm, a typical PLL will use several hundred microseconds to settle.

In a particular embodiment, for HD-FDD DL-to-UL switching, the specified guard period accommodates both the switching delay of the HD-FDD switch as well as the settling time of the PLL circuitry in the MTC UE to reach a stable frequency setting. In addition to allowing the PLL to reach a stable frequency upon switching, the HD-FDD switching also allows the AGC circuitry of the HD-FDD UE to settle. The minimum AGC settling time may be on the order of 2 to 3 LTE symbols. Combining the PLL and AGC settling time, the total typical switching time for the TX-to-RX or RX-to-TX HD-FDD implementation may be on the order of 0.5 milliseconds, or 1 slot of an LTE subframe. Combining the TX-to-RX and RX-to-TX switching time, the total implementation margin will be 2×0.5 milliseconds, or one subframe. This margin is consistent with the implementation margin for inter-frequency measurement gaps defined in Table 8.1.2.1 of TS 36.133 (i.e. 2×0.5 msec.).

As noted above, given that the RTT can be up to 667 microseconds, the need for up to 0.5 milliseconds for HD-FDD frequency switching implies that the total switching time requirement for TX-to-RX or RX-to-TX can be up to 1.17 milliseconds, or impacting 2 subframes. When a large number of cells have an RTT of much less that 667 microseconds, or less than 500 microseconds, the total HD-FDD switching time can be defined as 1 millisecond or 1 subframe for TX-to-RX or RX-to-TX in “normal” cells with a range of less than 75 km (corresponding to a RTT of 500 microseconds). When the cell range is extended and has a range greater than 75 km, 2 subframes can be reserved for HD-FDD switching for TX-to-RX or RX-to-TX transitions.

A typical PLL settling time to reach a stability of 0.1 ppm is on the order of several hundred microseconds. A minimum settling time for the MTC UE AGC can be at least 2 to 3 LTE symbols.

In particular embodiments, the implementation margin for Rx-to-Tx and Tx-to-Rx frequency switching time expected for support of half-duplex FDD operation for low complexity MTC UEs is nominally 1 subframe or 2×0.5 milliseconds for DL-to-UL and UL-to-DL switching and back.

In particular embodiments, the implementation margin for the Rx-to-Tx or Tx-to-Rx guard period can be defined to be 1 millisecond, or 1 subframe, for cells with a range of less than 75 km. The total implementation margin for support of half-duplex FDD for both the Rx-to-Tx and Tx-to-Rx guard periods is nominally 1 subframe.

In particular embodiments, the implementation margin for a Rx-to-Tx or Tx-to-Rx guard period can be defined to be 1.17 milliseconds, or 2 subframes, for cells with a range of greater than 75 km. The total implementation margin for support of half-duplex FDD for both the Rx-to-Tx and Tx-to-Rx guard periods is nominally 2 subframes.

FIG. 8 is a block diagram illustrating an example embodiment of a user equipment. The user equipment is an example of the wireless devices 110 illustrated in FIG. 1. Particular examples include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, or any other device that can provide wireless communication. The wireless device includes transceiver 810, processor 820, and memory 830. In some embodiments, transceiver 810 facilitates transmitting wireless signals to and receiving wireless signals from wireless network node 120 (e.g., via an antenna), processor 820 executes instructions to provide some or all of the functionality described herein as provided by the wireless device, and memory 830 stores the instructions executed by processor 820.

Processor 820 includes any suitable combination of hardware and software implemented in one or more integrated circuits or modules to execute instructions and manipulate data to perform some or all of the described functions of the wireless device. In some embodiments, processor 820 may include, for example, one or more computers, one more programmable logic devices, one or more central processing units (CPUs), one or more microprocessors, one or more applications, and/or other logic, and/or any suitable combination of the preceding. Processor 820 may include analog and/or digital circuitry configured to perform some or all of the described functions of wireless device 110. For example, processor 820 may include resistors, capacitors, inductors, transistors, diodes, and/or any other suitable circuit components.

Memory 830 is generally operable to store computer executable code and data. Examples of memory 830 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

In particular embodiments, processor 820 in communication with transceiver 810 transmits both uplink and downlink radio signal to network node 120. Other embodiments of the wireless device may include additional components (beyond those shown in FIG. 8) responsible for providing certain aspects of the wireless device's functionality, including any of the functionality described above and/or any additional functionality (including any functionality necessary to support the solution described above).

In particular embodiments, wireless device 110 may include an obtaining module, a determination module, and a switch module. The obtaining module may perform the processing functions of wireless device 110 related to obtaining a parameter indicative of a round trip time for a radio communication. For example, the obtaining module may obtain a round trip time for a radio communication between wireless device 110 and network node 120. The obtaining module may autonomously determine the information, or the obtaining module may receive the information from network node 120. In certain embodiments, the obtaining module may include or be included in processor 820. The obtaining module may include analog and/or digital circuitry configured to perform any of the functions of the obtaining module and/or processor 820. In particular embodiments, the obtaining module may communicate with the determination module.

The determination module may perform the uplink/downlink switch time determination functions of wireless device 110. For example, the determination module may determine, based on information received by the obtaining module, a number of time resources wireless device 110 should use to switch between uplink and downlink transmissions. In certain embodiments, the determination module may include or be included in processor 820. The determination module may include analog and/or digital circuitry configured to perform any of the functions of the determining module and/or processor 820. In particular embodiments, the determination module may communicate with the obtaining module and/or the switch module.

The switch module may perform the functions of wireless device 110 for switching between uplink and downlink transmissions. For example, the switch module may configure the radio resources of wireless device 110 to transmit or receive. As another example, the switch module may tune a local oscillator of wireless device 110 to a different frequency. In certain embodiments, the switch module may include or be included in processor 820. The switch module may include analog and/or digital circuitry configured to perform any of the functions of the switch module and/or processor 820. In particular embodiments, the switch module may communicate with the determination module.

FIG. 9 is a block diagram illustrating an example embodiment of a network node. Network node 120 can be an eNodeB, a nodeB, a base station, a wireless access point (e.g., a Wi-Fi access point), a low power node, a base transceiver station (BTS), a transmission point or node, a remote RF unit (RRU), a remote radio head (RRH), or other radio access node. Network node 120 includes at least one transceiver 910, at least one processor 920, at least one memory 930, and at least one network interface 940. Transceiver 910 facilitates transmitting wireless signals to and receiving wireless signals from a wireless device, such as wireless devices 110 (e.g., via an antenna); processor 920 executes instructions to provide some or all of the functionality described above as being provided by a network node 120; memory 930 stores the instructions executed by processor 920; and network interface 940 communicates signals to backend network components, such as a gateway, switch, router, Internet, Public Switched Telephone Network (PSTN), controller, and/or other network nodes 120. Processor 920 and memory 930 can be of the same types as described with respect to processor 820 and memory 830 of FIG. 8 above.

In some embodiments, network interface 940 is communicatively coupled to processor 920 and refers to any suitable device operable to receive input for network node 120, send output from network node 120, perform suitable processing of the input or output or both, communicate to other devices, or any combination of the preceding. Network interface 940 includes appropriate hardware (e.g., port, modem, network interface card, etc.) and software, including protocol conversion and data processing capabilities, to communicate through a network.

In particular embodiments, processor 920 in communication with transceiver 910 transmits/receives wireless signals, including uplink and downlink signals and control information, to/from wireless device 110. In particular embodiments, processor 920 in communication with transceiver 910 transmits uplink and downlink signals as described above to wireless device 110.

Other embodiments of network node 120 include additional components (beyond those shown in FIG. 9) responsible for providing certain aspects of the network node's functionality, including any of the functionality described above and/or any additional functionality (including any functionality necessary to support the solution described above). The various different types of radio network nodes may include components having the same physical hardware but configured (e.g., via programming) to support different radio access technologies, or may represent partly or entirely different physical components.

In particular embodiments, network node 120 may include an obtaining module, a determination module, a memory module, and a communication module. The obtaining module may perform the processing functions of network node 120 related to obtaining a parameter indicative of a round trip time for a radio communication. For example, the obtaining module may obtain a round trip time for a radio communication between wireless device 110 and network node 120. The obtaining module may autonomously determine the information, or the obtaining module may receive the information from wireless device 110. In certain embodiments, the obtaining module may include or be included in processor 920. The obtaining module may include analog and/or digital circuitry configured to perform any of the functions of the obtaining module and/or processor 920. In particular embodiments, the obtaining module may communicate with the determination module, the memory module, and/or the communication module.

The determination module may perform the uplink/downlink switch time determination functions of network node 120. For example, the determination module may determine, based on information received by the obtaining module, a number of time resources wireless device 110 should use to switch between uplink and downlink transmissions. In certain embodiments, the determination module may include or be included in processor 920. The determination module may include analog and/or digital circuitry configured to perform any of the functions of the determining module and/or processor 920. In particular embodiments, the determination module may communicate with the obtaining module, the memory module, and/or the communication module.

The memory module may include or be included in memory 930. In particular embodiments, the memory module may store an uplink/downlink switch time associated with a wireless device 110.

The communication module may perform the communication functions of network node 120. For example, the communication module may communicate information obtained by the obtaining module and/or determined by the determination module to wireless devices 110 or another network node 120. For example, the communication module may transmit signaling information to wireless device 110. The communication module may also receive information from wireless device 110 or other network nodes 120. For example, the communication module may receive signaling information from wireless device 110 or receive information from another network node 120. In certain embodiments, the communication module may include or be included in transceiver 910. The communication module may include a transmitter and/or a transceiver. In certain embodiments, the communication module may include or be included in processor 920. The communication module may include circuitry configured to wirelessly transmit messages and/or signals. In particular embodiments, the communication module may communicate with obtaining module, the determination module, and/or the memory module.

Some embodiments of the disclosure may provide one or more technical advantages. As an example, particular embodiments may include efficient use of available radio resources (e.g., UL and DL subframes) between a wireless device and a network node by adaptively selecting the switching time based on one or more criteria or measurements. A network node may be able to assign more radio resources for scheduling data transmission to a UE. A network node may have fewer constraints when scheduling data transmission to a UE because fewer radio resources may be wasted or may go unused when switching between UL and DL time resources.

Some embodiments may benefit from some, none, or all of these advantages. Other technical advantages may be readily ascertained by one of ordinary skill in the art.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

It will be appreciated by the person of skill in the art that various modifications may be made to the above described embodiments without departing from the scope of the present invention. For example, although embodiments of the present invention have been described with examples that include a communication system compliant to the 3GPP specified LTE standard specification, it should be noted that the solutions presented may be equally well applicable to other networks that support dual connectivity. The specific embodiments described above should therefore be considered exemplary rather than limiting the scope of the invention. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

Although the preceding embodiments have been described for example purposes, it will be appreciated that other example embodiments include variations of and extensions to these enumerated examples, in accordance with the detailed procedures and variants described above.

In the above-description, the terminology used is for the purpose of describing particular embodiments only and is not intended to be limiting. Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present disclosure. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, some embodiments may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the disclosure. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present disclosure. All such variations and modifications are intended to be included herein within the scope of present disclosure. Accordingly, the above disclosed subject matter is to be considered illustrative, and not restrictive, and the appended examples of embodiments are intended to cover all such modifications, enhancements, and other embodiments, which fall within the spirit and scope of present disclosure. Thus, the scope of present disclosure are to be determined by the broadest permissible interpretation of the present disclosure, and shall not be restricted or limited by the foregoing detailed description.

### ABBREVIATIONS USED IN THE PRECEDING DESCRIPTION INCLUDE

3GPP Third Generation Partnership Project
BS Base Station
BSC Base station Controller
CDMA2000 Code division multiple access 2000
D2D Device-to-Device
DL Downlink
E-CID enhanced cell ID
EDGE Enhanced Data rates for GSM Evolution
eNB Evolved Node B, base station
E-UTRAN Evolved Universal Terrestrial Radio Access Network
E-UTRA Evolved Universal Terrestrial Radio Access
FDD Frequency Division Duplex
GERAN GSM EDGE Radio Access Network
GSM Global System for Mobile communication
HD Half-Duplex
HRPD High Rate Packet Data
HSPA High Speed Packet Access
LTE Long Term Evolution
M2M Machine-To-Machine
MTC Machine-Type Communication
OTDOA Observed Time Difference of Arrival
PBCH Physical Broadcast Channel
PCC Primary Component Carrier
PCell Primary Cell
PCFICH Physical Control Format Indicator
PCI Physical cell identity
PDCCH Physical Downlink Control Channel
PDSCH Physical Downlink Shared Channel
PHICH Physical Hybrid ARQ Indicator Channel
PLL Phase Locked Loop
PSS Primary Synchronization Signal
PSTN Public Switched Telephone Network
RAN Radio Access Network
RAT Radio Access Technology
RB Resource Block
RE Resource Element
RNC Radio Network Controller
RRC Radio Resource control
RRH Remote Radio Head
RS Reference Signal
RSRQ Reference Signal Received Quality
RSSI Received Signal Strength Indicator
RTT Round Trip Time
SINR Signal-to-Interference Ratio
SRS Sounding Reference Signals
TDD Time division duplex
UE User Equipment
UL Uplink
UL RTOA UL Relative Time of Arrival
UTDOA UL Time Difference of Arrival
UTRA universal terrestrial radio access
UTRA FDD UTRA frequency division duplex
UTRA TDD UTRA time division duplex
WLAN Wireless Local Area Network

1. A method in a user equipment (UE), the UE capable of operating in half-duplex mode and is served by a network node, the method comprising:
obtaining a parameter indicative of a round trip time for a radio communication between the UE and the network node;
comparing the obtained parameter with a threshold;
determining, based on a result of the comparison of the parameter and the threshold, a switching time for switching the UE between uplink and downlink time resources; and
switching between uplink and downlink time resources within the determined switching time.

2. The method of claim 1, wherein determining the switching time comprises selecting one of at least two pre-determined switching times.

3. The method of claim 1, wherein the parameter comprises a timing advance command for adjusting uplink transmit timing of the UE.

4. The method of claim 1, wherein the parameter comprises the amount of adjustment the UE should apply to its uplink transmit timing with respect to a start time of a downlink radio frame of the network node.

5. The method of claim 1, wherein the parameter comprises a physical distance between the UE and the network node.

6. The method of claim 1, wherein obtaining the parameter comprises receiving the parameter from the network node.

7. The method of claim 1, wherein obtaining the parameter comprises the UE autonomously determining the parameter.

8. The method of claim 1, wherein the threshold is predetermined.

9. (canceled)

10. The method of claim 1, wherein the switching time comprises a first number of time resources if the parameter is less than or equal to the threshold and the switching time comprises a second number of time resources if the parameter is greater than the threshold.

11. (canceled)

12. (canceled)

13. A program stored on a non-transitory computer readable medium comprising instructions which when executed by a processor cause the processor to carry out the method of claim 1.

14. A method in a network node serving a UE that is capable of operating in half-duplex mode, the method comprising:
obtaining a parameter indicative of a round trip time for a radio communication between the UE and the network node;
comparing the obtained parameter with a threshold;
determining, based on a result of the comparison of the parameter and the threshold, a switching time for switching the UE between uplink and downlink time resources; and
communicating the parameter to the UE.

15. The method of claim 14, further comprising storing the switching time associated with the UE.

16. The method of claim 14, wherein determining the switching time comprises selecting one of at least two pre-determined switching times.

17. The method of claim 14, wherein the parameter comprises the switching time.

18. The method of claim 14, wherein the parameter comprises a threshold, the threshold indicating a distance for which the UE will determine a first switching time if the UE is closer to the network node than the threshold and the UE will determine a second switching time if the UE is farther from the network node than the threshold.

19. The method of claim 14, wherein the parameter comprises a timing advance command for adjusting uplink transmit timing of the UE.

20. The method of claim 14, wherein the parameter comprises the amount of adjustment the UE should apply to its uplink transmit timing with respect to a start time of a downlink radio frame of the network node.

21. (canceled)

22. A program stored on a non-transitory computer readable medium comprising instructions which when executed by a processor cause the processor to carry out the method of claim 14.

23. A user equipment (UE) that is capable of operating in half-duplex mode and is served by a network node, the UE comprising:
one or more processors; and
at least one memory, the memory containing instructions executable by the one or more processors whereby the UE is operable to:
obtain a parameter indicative of a round trip time for a radio communication between the UE and the network node;
compare the obtained parameter with a threshold;
determine, based on a result of the comparison of the parameter and the threshold, a switching time for switching the UE between uplink and downlink time resources; and
switch between uplink and downlink time resources within the determined switching time.

24. The UE of claim 23, wherein the UE is operable to determine the switching time by selecting one of at least two pre-determined switching times.

25. The UE of claim 23, wherein the parameter comprises a timing advance command for adjusting uplink transmit timing of the UE.

26. The UE of claim 23, wherein the parameter comprises the amount of adjustment the UE should apply to its uplink transmit timing with respect to a start time of a downlink radio frame of the network node.

27. The UE of claim 23, wherein the parameter comprises a physical distance between the UE and the network node.

28. The UE of claim 23, wherein the UE obtains the parameter by receiving the parameter from the network node.

29. The UE of claim 23, wherein the UE obtains the parameter by autonomously determining the parameter.

30. The UE of claim 23, wherein the threshold is predetermined.

31. (canceled)

32. The UE of claim 23, wherein the switching time comprises a first number of time resources if the parameter is less than or equal to the threshold and the switching time comprises a second number of time resources if the parameter is greater than the threshold.

33. (canceled)

34. (canceled)

35. A network node serving a UE that is capable of operating in half-duplex mode, the network node comprising:
one or more processors; and
at least one memory, the memory containing instructions executable by the one or more processors whereby the network node is operable to:
obtain a parameter indicative of a round trip time for a radio communication between the UE and the network node;
compare the obtained parameter with a threshold;
determine, based on a result of the comparison of the parameter and the threshold, a switching time for switching the UE between uplink and downlink time resources; and
communicate the parameter to the UE.

36. The network node of claim 35, wherein the network node is further operable to store the switching time associated with the UE.

37. The method of claim 35, wherein the network node is operable to determine the switching time by selecting one of at least two pre-determined switching times.

38. The network node of claim 35, wherein the parameter comprises the switching time.

39. The network node of claim 35, wherein the parameter comprises a threshold, the threshold indicating a distance for which the UE will determine a first switching time if the UE is closer to the network node than the threshold and the UE will determine a second switching time if the UE is farther from the network node than the threshold.

40. The network node of claim 35, wherein the parameter comprises a timing advance command for adjusting uplink transmit timing of the UE.

41. The network node of claim 35, wherein the parameter comprises the amount of adjustment the UE should apply to its uplink transmit timing with respect to a start time of a downlink radio frame of the network node.

42. (canceled)

43. (canceled)

44. (canceled)
